(19) United States
(12) Patent Application Publication
(10) Pub. No.: US 2006/0172773 A1
(43) Pub. Date: Aug. 3, 2006

(54) Mobile body communication system and communication fee discount method and program

(76) Inventors: Yusaku Morishita, Kanagawa (JP); Hiroteru Shimada, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/562,853

(22) PCT Filed: Jul. 23, 2004
(86) PCT No.: PCT/JP04/10465

§ 371 Date: Feb. 14, 2006

(30) Foreign Application Priority Data
Jul. 24, 2003 (JP) 2003-279046

(51) Int. Cl. H04B 1/38; H04M 1/00

(52) U.S. Cl. 455/560

(57) ABSTRACT

A communication fee service is provided to improve services for users and the utilization ratio, thereby increasing the benefits of mobile communication carriers. A mobile communication system comprising a mobile terminal (1) having a location measurement function and being capable of locating its position, a radio access network (2) and a core network (3) including a specific communication information server (407). A user defines one or more specific communication areas and one or more other communication parties by contract with a mobile communication carrier which manages the mobile communication system such that reduced communication fees (specific communication fees) are applied to communication with the other communication parties in the specific communication areas. The specific communication information server stores information on the user, the specific communication areas and the other communication parties. When the mobile terminal makes a call to the other communication party in the specific communication area and the other communication party responds to the call, the mobile communication carrier charges the user the specific communication fee. The specific communication fee differs from communication fees charged to general users each having a contract relationship with the mobile communication carrier.

### TECHNICAL FIELD

The present invention relates to a mobile communication system, and more particularly, to a communication fee service provided by a mobile communication system.

### BACKGROUND ART

In recent years, Japanese cellular mobile telephone communication carriers have started providing mobile communication service based on the WCDMA (Wideband Code Division Multiple Access) system. The WCDMA system was proposed as a third generation mobile communication system compliant with a global standard for IMT-2000 (International Mobile Telecommunications 2000). The WCDMA system has come into practical use mainly in Europe and Japan. As such, from mobile telephone service based on the PDC (Personal Digital Cellular) system whose scope of use is currently within Japan, the trend is shifting toward the realization of the service available throughout the world.

The CDMA system, the basis of the WCDMA system, is a multiple access system in which a plurality of cellular phones simultaneously perform communication in the same frequency band. In the WCDMA system, the CDMA frequency band is broadened. As the advantages of the broadbandization may be cited the improvement of reception characteristic resulting from higher multipath resolution and an increase in the number of allowable accommodated users. Additionally, in data communication, throughput is enhanced, which enables high-speed data communication.

In Japanese Patent Laid-Open No. 2000-261575, there is disclosed a technique to provide the user of a terminal who enters in a roaming destination network with charge information according to the accounting system of the network in the WCDMA mobile communication system or the like.

On the other hand, wireless LAN (Local Area Network) service has been recently provided only in limited, specific places or areas to promote the availability of data communication outside the office.

Patent Document 1: Japanese Patent Laid-Open No. 2000-261575. (Chapter 0016, FIGS. 1 and 2)

### DISCLOSURE OF THE INVENTION

Problems That the Invention is to Solve

The conventional systems described above, however, has a problem in that, in the case of, for example, WCDMA, the rate of increase in the number of users (subscribers) slows down, and also communication carriers or providers in Europe or other foreign countries hesitate to start the service. This may be because the conventional system is not considered as superior in terms of service as compared to the current mobile communication system. Under the present circumstances, even if a user has a cellular phone that can be used around the world, he/she cannot enjoy the benefit thereof. Besides, there are communication carriers which provide pay wireless LAN service only in limited, specific places or areas. This service is also not preferable in view of business.

The reason is that the service is provided in limited number of areas, and does not cover wide service area as a public service.

It is therefore an object of the present invention to provide services concerning communication fees, which have not been offered by the conventional mobile communication systems, to improve services for users and the utilization ratio, thereby increasing the benefits of mobile communication carriers or providers.

Means of Solving the Problems

In accordance with an aspect of the present invention, there is provided a mobile communication system comprising a mobile terminal having a location measurement or position location function, a radio access network including a base transceiver station or wireless base station that has a session with the mobile terminal, and a core network connected to the radio access network for performing circuit switching and packet switching. The core network includes a specific communication information server for storing information on a user who uses the mobile terminal, one or more specific communication areas in which specific communication fees are applied to reduce communication fees for the mobile terminal, and one or more other communication parties, communication with which is charged at the specific communication fees.

In the mobile communication system of the present invention, the specific communication area is defined by a contract between the user of the mobile terminal and the mobile communication carrier or provider that manages the mobile communication system.

In the mobile communication system of the present invention, the specific communication areas may be set by contract in the service areas of one or more mobile communication carriers each managing the mobile communication system in Japan and one or more mobile communication carriers each managing the mobile communication system abroad.

In the mobile communication system of the present invention, when the user of the mobile terminal is located in the specific communication area and makes a call to a mobile terminal located outside the area, communication with which is charged by contract at the specific communication fee, the specific communication fee is applied to the call.

In the mobile communication system of the present invention, when the mobile terminal is incapable of locating its position, the core network compares the past location measurement data of the mobile terminal obtained therefrom with location data obtained from the base transceiver station, and uses the location data as the location measurement data.

In the mobile communication system of the present invention, the specific communication information server requests the mobile terminal for the location measurement data thereof while the mobile terminal is in communication.

In the mobile communication system of the present invention, the mobile terminal displays or indicates that it is located in the specific communication area.

In the mobile communication system of the present invention, the specific communication fee is determined according to the amount of traffic in the specific communication area.

In accordance with another aspect of the present invention, there is provided a communication fee service method applied to a mobile communication system, wherein the user of mobile communication carrier's services defines one or more specific communication areas in the service area of the mobile communication carrier, and the mobile communication carrier reduces fees charged to the user for communication in the specific communication area.

In accordance with another aspect of the present invention, there is provided a communication fee service method applied to a mobile communication system, wherein a plurality of users of mobile communication carrier's services define their specific communication areas, respectively, in the service area of the mobile communication carrier, and the mobile communication carrier reduces fees charged to each of the users for communication in the specific communication area.

In the communication fee service method applied to a mobile communication system of the present invention, the specific communication areas of the respective users may overlap partly or completely.

In accordance with another aspect of the present invention, there is provided a communication fee service method applied to a mobile communication system, wherein, when a first specific communication area is set for a mobile terminal in the service area of a first mobile communication carrier and a second specific communication area is set for another mobile terminal in the service area of a second mobile communication carrier in business partnership with the first mobile communication carrier, the first mobile communication carrier reduces fees for communication between the mobile terminals in the first and second specific communication areas.

In accordance with another aspect of the present invention, there is provided a communication fee service method applied to a mobile communication system comprising a mobile terminal having a location measurement function, a radio access network including a base transceiver station that has a session with the mobile terminal, and a core network connected to the radio access network for performing circuit switching and packet switching. The communication fee service method comprises the steps of: the mobile terminal transmitting confirmation request data to request the core network to check whether or not the mobile terminal is located in its specific communication area; the core network checking the location measurement data of the mobile terminal contained in the confirmation request data with information on the specific communication area of the mobile terminal defined by contract to determine whether or not the mobile terminal is located in the specific communication area; the core network informing the mobile terminal, when the mobile terminal is located in the specific communication area, that the mobile terminal is located in the specific communication area; and the mobile terminal displaying, when having been informed that the mobile terminal is located in the specific communication area, the indication of the specific communication area on the standby or idle screen.

In accordance with another aspect of the present invention, there is provided a communication fee service method applied to a mobile communication system comprising a mobile terminal having a location measurement function, a radio access network including a base transceiver station that has a session with the mobile terminal, and a core network connected to the radio access network for performing circuit switching and packet switching. The communication fee service method comprises the steps of: the mobile terminal transmitting location measurement data and a flag indicating that the mobile terminal is located in its specific communication area to the core network; the core network recognizing, when having received the flag, that the mobile terminal has been located in the specific communication area, and referring to the timestamp of the location measurement data to determine whether or not the location measurement data has expired; the core network checking the area based on the location measurement data when the location measurement is still valid, and also checking the other communication party; the core network checking the area based on the past location measurement data and location data of the mobile terminal obtained from the base transceiver station when the location measurement is already invalid, and also checking the other communication party; the core network determining whether or not specific communication which is charged at a specific communication fee is to be performed based on the results of the checks for the area and the other communication party; the core network informing the mobile terminal, when the specific communication is to be performed, that the communication is the specific one if the other communication party answers the call, and charging the specific communication fee; and the mobile terminal determining whether or not the information from the core network indicates the specific communication, and, when the information indicates the specific communication, displaying that the communication to be performed is the specific one.

In accordance with another aspect of the present invention, there is provided a communication fee service method applied to a mobile communication system comprising a mobile terminal having a location measurement function, a radio access network including a base transceiver station that has a session with the mobile terminal, and a core network connected to the radio access network for performing circuit switching and packet switching. The communication fee service method comprises the steps of: the core network requesting the mobile terminal for location measurement data; the mobile terminal transmitting the location measurement data to the core network; the core network receiving the location measurement data, and checking the area to determine whether or not it corresponds to a specific communication area; the core network informing the mobile terminal, when the area corresponds to the specific communication area, that the communication is the specific one, and reviewing the charge rate; and the mobile terminal determining whether or not the communication is the specific one, and, when the specific communication is being performed, displaying the indication of the specific communication.

In accordance with another aspect of the present invention, there is provided a communication fee service program causing a computer to perform the functions of: receiving from a mobile terminal confirmation request data requesting to check whether or not the mobile terminal is located in its specific communication area; checking, on receipt of the confirmation request data, the location measurement data of the mobile terminal contained in the confirmation request data with information on the specific communication area of the mobile terminal defined by contract to determine whether or not the mobile terminal is located in the specific communication area; and informing the mobile terminal, when the mobile terminal is located in the specific communication area, that the mobile terminal is located in the specific communication area.

In accordance with another aspect of the present invention, there is provided a communication fee service program causing a computer to perform the functions of: receiving from a mobile terminal location measurement data and a flag indicating that the mobile terminal is located in its specific communication area; recognizing, when having received the flag, that the mobile terminal has been located in the specific communication area, and referring to the timestamp of the location measurement data to determine whether or not the location measurement data has expired; checking the area based on the location measurement data when the location measurement is still valid, and also checking the other communication party; checking the area based on the past location measurement data and location data of the mobile terminal obtained from a base transceiver station when the location measurement is already invalid, and also checking the other communication party; determining whether or not specific communication which is charged at a specific communication fee is to be performed based on the results of the checks for the area and the other communication party; and informing the mobile terminal, when the specific communication is to be performed, that the communication is the specific one if the other communication party answers the call, and charging the specific communication fee.

In accordance with another aspect of the present invention, there is provided a communication fee service program causing a computer to perform the functions of: requesting a mobile terminal for location measurement data; receiving the location measurement data, and checking the area to determine whether or not the mobile terminal is located in a specific communication area; and informing the mobile terminal, when the mobile terminal is located in the specific communication area, that the communication is the specific one, and reviewing the charge rate.

### EFFECT OF THE INVENTION

As is described above, in accordance with the present invention, a user defines one or more specific communication areas in which specific communication fees, i.e., reduced communication fees are applied by contract with a mobile communication carrier or provider. Thereby the user can use his/her mobile terminal as an extension telephone in the office at the specific communication fees.

In terms of data communication, the mobile terminal can be used as in a wireless LAN within the specific communication area in which the specific communication fee is applied. In other words, it is possible to provide convenience such that the user can access a network wherever in the specific communication area without detracting from the portability of the mobile terminal.

Moreover, if a global standard, WCDMA is applied to the mobile communication system, the specific communication fee service can be offered in countries or places around the world where the WCDMA system is used. Thus, international telephone communication fees can be reduced.

Besides, the application of the specific communication fees may increase the number of users and produce higher traffic due to their use of the mobile terminal as an extension telephone. Consequently, mobile communication carriers can raise profits from communication fees even through a low-margin/high-turnover style of service.

Further, the areas in which the specific communication fees are applied may include areas generally having high traffic volumes such as urban areas and those having relatively low traffic volumes such as suburban areas or local regions. As such, the specific communication fees may be adjusted according to areas to increase profits.

Still further, recent progress in IP (Internet Protocol) communication has realized low-price voice communication between wired telephones through techniques for voice communication over IP. With that background, voice communication over IP will be commercially available in the mobile communication network. The application of the mobile communication system of the present invention will enable a further reduction in communication fees for voice communication.

### BEST MODE FOR CARRYING OUT THE INVENTION

FIG. 1 is a diagram showing the configuration including a mobile communication system according to an embodiment of the present invention.

FIG. 2 is a block diagram showing the construction of a radio access network, a core network and a network according to the embodiment of the present invention.

Referring to FIGS. 1 and 2, a description will be given of the mobile communication system according to the present invention. The mobile communication system of the present invention comprises a mobile terminal or user equipment (UE) 1, a radio access network (RAN) 2, and a core network (CN) 3 including a specific communication information server 407. The mobile communication system is connected to the other communication party 5 via a network 4.

The mobile terminal 1 has a location measurement or position location function such as GPS (Global Location measurement System) to locate the position thereof. With this function, the mobile terminal 1 obtains location measurement data on its location, and transmits/receives data including the location measurement data to/from the radio access network 2. The user of the mobile terminal 1, who is also the user of mobile communication carrier's services, subscribes to the mobile communication carrier for the application of specific communication fees, i.e., reduced communication fees.

The radio access network 2 includes a base transceiver station (BTS) 401 for having a session with the mobile terminal 1 through a radio channel and a radio network control equipment (RNC) 402. The radio access network 2 is connected to the core network 3.

The core network 3 includes a circuit switching controller consisting of a mobile-services switching center (MSC) 403 and a gateway 404, a packet switching controller consisting of a serving central packet radio service center (SGSN) 405 and a packet gateway 406, and the specific communication information server 407.

The specific communication information server 407 is provided with a storage, a controller (computer) and the like. The specific communication information server 407 stores in the storage information on each user (contract conditions between the user and mobile communication carrier, and his/her user ID), specific communication areas in which specific communication fees or reduced communication fees are applied (latitude and longitude at which each specific communication area is located, etc.), the other communication parties 5 (the telephone numbers of the other communication parties 5) and the like. The controller of the specific communication information server 407 has the functions of requesting a calling user (the user of the mobile terminal 1) for location measurement data, performing an area check based on the location measurement data to determine whether or not the mobile terminal 1 is located in its specific communication area, checking whether or not a specific communication fee is applied by contract to communication with the other communication party 5, and charging the user (the user of the mobile terminal 1) a specific communication fee or a regular communication fee.

The network 4 includes a public switched telephone network/mobile communication network 408 and the Internet 409. The network 4 is connected to the core network 3 and the other communication party 5 on a public switched telephone network/mobile communication network.

The other communication party 5 is a mobile terminal on a public switched telephone network (PSTN), a mobile communication network other than the core network 3, or the like.

In the following, a description will be given of the mobile communication system for offering specific communication fees referring to FIG. 1. By contract with a mobile communication carrier which manages the mobile communication system shown in FIG. 1, a user defines one or more areas where specific communication fees, i.e., reduced communication fees are applied (herein referred to as specific communication area). The user also specifies one or more other communication parties (the other communication party depicted in FIG. 6), communication with which is charged by contract at the specific communication fees.

A communication fee before reduction is herein is herein referred to communication fee or regular communication fee. Also, the area in which the regular communication fee is applied is referred to as regular communication area. The specific communication information server 407 stores information on the user, the specific communication area and the other communication party 5 (telephone number). When the user of the mobile terminal 1 makes a call to the other communication party 5 in the specific communication area and the other communication party 5 responds to the call, the mobile communication carrier charges the user the specific communication fee. The specific communication fee differs from regular communication fees charged to general users each having a contract relationship with the mobile communication carrier.

Referring now to FIG. 3, a description will be given in detail of the mobile terminal 1 of the present invention. FIG. 3 is a block diagram showing the mobile terminal 1 according to the embodiment of the present invention.

The mobile terminal 1 includes a location measurement controller 501, a radio antenna 502, a radio controller 503, a CPU (Central Processing Unit) 504, a ROM (Read Only Memory) 505, a RAM (Random Access Memory) 506, a display 507, a key input unit 508, a voice controller 509, a microphone 510, a receiver 511, a speaker 512, an external interface (I/F) 513, and a power source 514.

If used in a system compliant with a global standard for IMT-2000, such as the WCDMA system, the mobile terminal 1 is additionally provided with an UIM (User Identity Memory) 515. The UIM 515 is a storage medium that stores the telephone number of the mobile terminal specified in a contract between the user and mobile communication carrier as well as contract terms and conditions. As such a case, when a global standard system such as WCDMA is applied to the mobile communication system, the specific communication fee service can be offered in countries or places around the world where the WCDMA system is adopted. Thus, international telephone communication fees can be reduced.

Examples of the mobile terminal 1 include, in addition to the one that functions as a cellular phone, a data communication dedicated terminal not having the display 507, key input unit 508, voice controller 509, microphone 510, receiver 511, and speaker 512. Besides, the external interface 513 may be USB (Universal Serial Bus), PCMCIA (Personal Computer Memory Card International Association) or a communication carrier dedicated interface.

Referring next to FIG. 4, a description will be given of an outline of the specific communication fee service for the application of specific communication fees provided in the mobile communication systems. A mobile communication carrier A310 (first mobile communication carrier) and, a mobile communication carriers B320, C330 and D340 (second mobile communication carriers) each manage the mobile communication system shown in FIG. 1. In the service areas of the first and second mobile communication carriers, specific communication areas 201 and 202 (first specific communication areas), and specific communication areas 204, 206 and 208 (second specific communication areas) are set, respectively. The mobile communication carriers provide the specific communication fee service by which specific communication fees are applied in their specific communication areas. It is assumed that the mobile communication carrier A310 is involved in business cooperation with the mobile communication carriers B320, C330 and D340. In FIG. 4, the reference numerals 211, 212, 221, 222, 231, 232, 241, 242, 251 and 252 represent mobile terminals. Incidentally, in FIG. 4, each of communications 210, 220, 230, 240 and 250 does not indicate a communication channel or path, but indicates the relation between a mobile terminal that transmits signals and the other one that receives the signals transmitted therefrom.

The mobile terminals 211, 212, 221, 222, 231 and 241 can receive the communication fee service for the application of specific communication fees by contract with the mobile communication carrier A310. In other words, the users of the mobile terminals 211, 212, 221, 222, 231 and 241 subscribe to the mobile communication carrier A310 for the communication fee service by which the application of specific communication fees is available. On the other hand, the mobile terminals 232, 242, 252 and 252 are specified as the other communication parties 5 in the contract with the mobile communication carrier A3010, and located in the specific communication areas where the communication fee service is applied with specific communication fees.

In Japan 1000, there exist a service area 203 of the mobile communication carrier A310 and a service area 205 of the mobile communication carrier B320.

In the following, a description will be given of examples of communication patterns to which specific communication fees are applied.

The communication 210 between the mobile terminals 211 and 212 in the specific communication area 201 will be hereinafter referred to as “in-area specific communication”. As examples of the “in-area specific communication” may be cited in-factory communications, internal or extension telephone calls through telephones substituted for fixed telephones in an office where the floor layout is frequently changed, and the like. Additionally, in terms of data communication, the “in-area specific communication” can be performed as in a wireless LAN. That is, it is possible to provide convenience such that each user can access a network wherever in the specific communication area without detracting from the portability of the mobile terminal.

Besides, the communication 220 between the mobile terminal 221 in the specific communication area 201 and the mobile terminal 222 in the specific communication area 202 will be hereinafter referred to as “inter-area specific communication”. As examples of the “inter-area specific communication” may be cited internal telephone calls between main and branch offices through dedicated telephones (e.g. extension telephones on lines leased from a wired communication carrier).

Next, an example will be given of communication, to which specific communication fees are applied, between the service areas of a plurality of mobile communication carriers.

The mobile terminal 232 is located within the specific communication area 204 in the service area 205 of the mobile communication carrier B320, which offers the communication fee service for the application of specific communication fees, in business partnership with the mobile communication carrier A310. In such a case, the communication 230 between the mobile terminals 232 and 231 will be hereinafter referred to as “inter-mobile communication carrier specific communication”. The “inter-mobile communication carrier specific communication” may be utilized, for example, when a user wishes to receive the communication fee service for the application of specific communication fees in the service area of a mobile communication carrier other than the carrier that he/she subscribes to, or when a mobile terminal of the other communication party is a subscriber terminal to a mobile communication carrier other than the carrier that the user subscribes to.

Next, an example will be given of communication, to which specific communication fees are applied, between countries.

The mobile terminal 242 is located within the specific communication area 206 in the service area 207 of the mobile communication carrier C330, which offers the communication fee service for the application of specific communication fees in a foreign country A 2000, in business partnership with the mobile communication carrier A310. In such a case, the communication 240 between the mobile terminals 242 and 241 will be hereinafter referred to as “international specific communication”. As an example of the “international specific communication” may be cited internal telephone calls between main and overseas branch offices.

Next, another example will be given of communication, to which specific communication fees are applied, between countries.

The mobile terminal 252 is located within the specific communication area 208 in the service area 209 of the mobile communication carrier D340, which offers the communication fee service for the application of specific communication fees in a foreign country B 3000, in business partnership with the mobile communication carrier A310. In such a case, as with the communication 240, the communication 250 between the mobile terminals 252 and 251 will also be hereinafter referred to as “international specific communication”. As an example of the “international specific communication” may be cited internal telephone calls between overseas branch offices.

A user can set a plurality of specific communication areas by contract in the service areas of mobile communication carriers which offer the communication fee service for the application of specific communication fees throughout the world as well as in the service area of the carrier that he/she subscribes to. That is, the user can set and subscribe to specific communication areas, such as those 201, 202, 204, 206 and 208, throughout the world.

FIG. 5 is a diagram showing specific communication areas of a plurality of users who subscribe to a mobile communication carrier according to the embodiment of the present invention.

Referring to FIG. 5, specific communication areas 201, 202, 201a, 201b and 201c are located in the service area 203 of the mobile communication carrier A310. A user A subscribes to the specific communication areas 201 and 202. Similarly, a user B subscribes to the specific communication area 201a, and a user C subscribes to the specific communication areas 201b and 201c. Candidates of the users A, B and C include business organizations such as a bank and a company or a corporation, public organizations such as a local authority and a public corporation, educational institutions such as a university or a college, health care institutions such as a medical center or a hospital, and the like.

The user A has branch offices or factories in geographically separate areas, and has set the separate specific communication areas 201 and 202 by contract with the mobile communication carrier A310. Namely, the specific communication areas defined by contract are separated from each other.

The user B has branch offices or factories in geographically adjacent areas, and has set the specific communication area 201a, which partly overlaps the specific communication areas 201 and 202 of the user A, by contract with the mobile communication carrier A310. Namely, the specific communication area defined by contract partly overlaps the specific communication areas to which another user subscribes.

The user C has branch offices or factories in relatively narrow areas, and has set the specific communication areas 201b and 201c, which completely and partly overlap the specific communication area 201 of the user A, respectively, by contract with the mobile communication carrier A310. Namely, the respective specific communication areas defined by contract partly and completely overlap the specific communication area to which another user subscribes.

In the following, a description will be given of the adjustment of specific communication fees according to areas (specific communication areas) where the specific communication fees are applied.

The mobile communication carrier may adjust specific communication fees in areas generally having high traffic volumes such as urban areas (e.g. the specific communication area 201 in FIG. 5) and those having relatively low traffic volumes such as suburban areas or local regions (e.g. the specific communication area 202 in FIG. 5). In other words, the mobile communication carrier may adjust the discount rate for specific communication fees according to the volume of traffic to thereby increase combined profits in urban and suburban areas.

As an example, specific communication fees may be adjusted such that the reduced rate for specific communication fees is increased in areas having high traffic volumes, while it is decreased in areas having low traffic volumes. In this case, although the utilization ratio in areas having low traffic volumes will further drops, the utilization ratio in areas having high traffic volumes will become higher.

As another example, specific communication fees may be adjusted such that the reduced rate for specific communication fees is decreased in areas having high traffic volumes, while it is increased in areas having low traffic volumes. In this case, although the utilization rate in areas having high traffic volumes may drop, the utilization ratio in areas having low traffic volumes is likely to increase.

In this manner, by adjusting specific communication fees according to areas, the mobile communication carrier can increase the number of users (subscribers), and also raise profits from communication fees even through a low-margin/high-turnover style of service because of higher traffic due to their use of the mobile terminals as extension telephones.

Referring next to FIG. 6, a description will be given of an example of communication in the case where the other communication party is a mobile terminal that uses a public switched telephone network or a subscriber terminal to a mobile communication carrier not in business partnership with the mobile communication carrier A310.

FIG. 6 is a diagram showing the case where, in the communication fee service for the application of specific communication fees according to the embodiment of the present invention, the other communication party 311 is a mobile terminal on a public switched telephone network or other than the other communication party 5 shown in FIG. 1. Incidentally, in FIG. 6, communication 312 does not indicate a communication channel or path, but indicates the relation between a mobile terminal that transmits signals and the other one that receives the signals transmitted therefrom. Also in FIG. 6, the other communication party 311 is a mobile terminal that uses a public switched telephone network and a subscriber terminal to a mobile communication carrier not in business partnership with the mobile communication carrier A310 (unaffiliated mobile communication carrier). The other communication party 311 has been registered by contract with the mobile communication carrier A310 as the other communication party, communication with which is charged at a specific communication fee.

In the case where the user of a mobile terminal 211, who subscribes to the communication fee service for the application of specific communication fees, is located in the specific communication area 201 and makes a call to the other communication party 311, the communication 312 is regarded as specific communication, and the specific communication fee is applied thereto. However, when the other communication party 311 makes a call to the mobile terminal 211, the specific communication fee is not applied to the communication.

In the following, a description will be given of the conditions for a user to receive the communication fee service for the application of specific communication fees referring to FIG. 6. The user is required to define one or more specific communication areas and one or more other communication parties (hereinafter referred to as specific communication fee-applicable specific communication areas/other communication parties) by contract with a mobile communication carrier such that a specific communication fee is applied to communication with the other communication party when he/she is in the specific communication area. Incidentally, there is no limitation on the number of the specific communication fee-applicable specific communication areas/other communication parties, and any number of them can be specified in the contract. Additionally, it is possible to set by contract the specific communication fee-applicable specific communication areas/other communication parties not only in Japan but also in countries or places around the world where the specific communication fee service for the application of specific communication fees is offered by the mobile communication system of the present invention.

FIG. 7 is a diagram for explaining a specific communication area in which a specific communication fee is applied according to the embodiment of the present invention. The range of the specific communication area is defined by the latitude and longitude. For example, a specific communication area 305 is set to range from latitude ◯ degrees, ◯ seconds and ◯ minutes north to X degrees, X seconds and X minutes north, and from longitude Δ degrees, Δ seconds and Δ minutes east to □ degrees, □ seconds and □ minutes east.

Referring to FIG. 7, a description will be given of the cases where a specific communication fee is charged and where a regular communication fee is charged.

Case 1 (Specific Communication Fee Charge): it is assumed that the user of the mobile terminal 1 has set by contract the specific communication area 305 as his/her specific communication area. When the user is located in the specific communication area 305 and makes a call to the other communication party specified in the contract so that a specific communication fee is applied to communication therewith, the mobile communication carrier charges to the user the specific communication fee. Incidentally, in FIG. 7, the mobile terminal 1 of this case is represented by a mobile terminal in specific communication A302 or B303 depending on the location thereof.

Case 2 (Regular Communication Fee Charge): it is assumed that the user of the mobile terminal 1 has set by contract the specific communication area 305 as his/her specific communication area. When the user is located outside the specific communication area 305 and makes a call to the other communication party specified in the contract so that a specific communication fee is applied to communication therewith, the mobile communication carrier charges to the user a regular communication fee. Incidentally, in FIG. 7, the mobile terminal 1 of this case is represented by a mobile terminal in regular communication A301 or B304 depending on the location thereof.

Case 3 (Switch from Specific Communication Fee Charge to Regular Communication Fee Charge): it is assumed that the user of the mobile terminal 1 (mobile terminal in specific communication B303) has set by contract the specific communication area 305 as his/her specific communication area. When the user moves from the inside of the specific communication area 305 to the outside during communication with the other communication party specified in the contract so that a specific communication fee is applied to communication therewith, as indicated by the mobile terminal in regular communication B304, a charge rate is changed from the specific communication fee to the regular one.

Case 4 (Switch from Regular Communication Fee Charge to Specific Communication Fee Charge): when the user of the mobile terminal 1 (mobile terminal in regular communication A301) moves from the outside of the specific communication area 305 to enter therein during communication with the other communication party specified in the contract so that a specific communication fee is applied to communication therewith, as indicated by the mobile terminal in specific communication A302, a charge rate is changed from the regular communication fee to the specific one.

In the following, the operation of the mobile communication system of the present invention will be described in detail referring to FIGS. 8 to 10. In FIGS. 8 to 10, the process (steps S102 to S105, S202 to S213, S301 to S303, and S305 to S308) on the core network 3 side is performed by the specific communication information server 407 (e.g. a computer serving as the controller of the specific communication information server 407) except for the process in step S202.

FIG. 8 is a flowchart showing the display operation of the mobile terminal in standby mode according to the embodiment of the present invention. More specifically, FIG. 8 shows the operation flow when the mobile terminal 1 in standby mode is to inform the user of the area where it is located by displaying specific or regular communication area indication on the standby or idle screen.

First, the mobile terminal 1 transmits confirmation request data to request the core network 3 to check whether or not the mobile terminal 1 is located in its specific communication area (step S101). Having received the request to check whether or not the mobile terminal 1 is located in the specific communication area from the mobile terminal 1, the core network 3 checks the location measurement data of the mobile terminal 1 contained in the confirmation request data with information on the specific communication area to which the mobile terminal subscribes (step S102). The core network 3 determines whether the mobile terminal 1 is located in the specific communication area or regular communication area (step S103). If the mobile terminal 1 is located in the specific communication area (step S103/Y), the core network 3 informs the mobile terminal 1 that the mobile terminal 1 is located in the specific communication area (specific communication area notification) (step S104). On the other hand, if the mobile terminal 1 is located in the regular communication area (step S103/N), the core network 3 informs the mobile terminal 1 that the mobile terminal 1 is located in the regular communication area (regular communication area notification) (step S105).

Next, the mobile terminal 1 determines whether the specific communication area notification or the regular communication area notification has been received (step S106). If having received the specific communication area notification (step S106/Y), the mobile terminal 1 displays the specific communication area indication on the standby screen of the display 507 (step S107). If having received the regular communication area notification (step S106/N), the mobile terminal 1 displays the regular communication area indication on the standby screen of the display 507 (step S108).

FIG. 9 shows the operation flow from when the mobile terminal 1 makes a call while the specific communication area indication is displayed to when the mobile terminal 1 enters communication mode.

When the user makes a call, the mobile terminal 1 initiates a call operation sequence (step S201). In response to the initiation of the call operation sequence by the mobile terminal 1, the core network 3 also initiates a call operation sequence (the mobile-services switching center 403 or the serving central packet radio service center 405 starts to operate) (step S202).

Incidentally, a call establishment signal, etc. from the mobile terminal 1 used in the call operation sequence contains the location measurement data of the mobile terminal 1 and a flag (specific communication area flag) indicating that the mobile terminal 1 is located in the specific communication area. The mobile terminal 1 locates its position at regular intervals to obtain location measurement data each having a timestamp. When the mobile terminal 1 stays in the state incapable of locating its position, data obtained by the last location measurement is utilized as location measurement data. Consequently, the location measurement data having an old timestamp is transmitted to the core network 3.

The core network 3 checks the presence or absence of the specific communication area flag from the mobile terminal 1 (step S203). When having received the specific communication area flag (step S203/Y), the core network 3 temporarily recognizes that the mobile terminal 1 has been located in the specific communication area. Then, the core network 3 refers to the timestamp of the location measurement data to determine whether or not the location measurement data has expired (whether or not a prescribed period of time has elapsed which is a time period determined suitably depending on the user's state such as walking or moving in a vehicle to improve the reliability of the location measurement data) (step S204).

If the location measurement is still valid (step S204/Y), the core network 3 checks the area based on the location measurement data, and also checks the other communication party (step S205).

If the location measurement is already invalid (step S204/N), the core network 3 determines that the mobile terminal 1 has been being incapable of locating its position. In such a case, the core network 3 compares past location measurement data obtained from the mobile terminal 1 with location data of the mobile terminal 1 obtained from the base transceiver station 401 (base transceiver station data). If the location indicated by the past location measurement data matches or is in the vicinity of that indicated by the base transceiver station data, the core network 3 utilizes the base transceiver station data as the location measurement data of the mobile terminal 1. The core network 3 checks the area and the other communication party through the specific communication information server 407 (step S206).

The core network 3 determines whether or not specific communication which is charged at a specific communication fee is to be performed based on the results of the checks for the area and the other communication party (step S207). If the specific communication is to be performed (step S207/Y), when the other communication party answers the call (step S208), the core network 3 informs the mobile terminal 1 that the communication is the specific one (specific communication notification) (step S209). Thus, the core network 3 starts calculation of the specific communication fee (step S210). If the specific communication is not to be performed (step S207/N), when the other communication party answers the call (step S211), the core network 3 informs the mobile terminal 1 that the communication is the regular one (regular communication notification) (step S212). Thus, the core network 3 starts calculation of the regular communication fee (step S213).

The mobile terminal 1 determines whether or not the information from the core network 3 indicates the specific communication (step S214). If the information indicates the specific communication (step S214/Y), the mobile terminal 1 displays that the communication is the specific one (specific communication indication) on the display 507 (step S215). If the information does not indicate the specific communication (step S214/N), the mobile terminal 1 displays that the communication is the regular one (regular communication indication) on the display 507 (step S216).

FIG. 10 is a flowchart showing operation for reviewing the charge rate during communication according to the embodiment of the present invention. More specifically, FIG. 10 is a flowchart showing the case where the mobile terminal 1 moves into or out of the specific communication area during communication and performs specific communication and regular communication alternately.

The core network 3 constantly checks whether or not the mobile terminal 1 is located in the specific communication area while the mobile terminal 1 is in communication (step S302), and determines whether or not location measurement data therefrom has expired (step S301). If the location measurement is already invalid (step S301/Y), the core network 3 requests the mobile terminal 1 for location measurement data (step S303).

Having received the request for location measurement data from the core network 3, the mobile terminal 1 transmits the location measurement data to the core network 3 (step S304). Upon receipt of the location measurement data, the core network 3 checks the area (step S305) to determine whether or not it corresponds to the specific communication area (step S306).

When the area corresponds to the specific communication area (step S306/Y), the core network 3 informs the mobile terminal 1 that the communication is the specific one (specific communication notification), and reviews the charge rate (step S307). That is, if the communication was performed in the regular communication area before the area check, the charge rate is changed to the specific communication fee. On the other hand, if the communication was performed in the specific communication area also before the area check, the charge rate remains unchanged at the specific communication fee.

When the area corresponds to the regular communication area (step S306/N), the core network 3 informs the mobile terminal 1 that the communication is the regular one (regular communication notification), and reviews the charge rate (step S308). That is, if the communication was performed in the specific communication area before the area check, the charge rate is changed to the regular communication fee. On the other hand, if the communication was performed in the regular communication area also before the area check, the charge rate remains unchanged at the regular communication fee.

The mobile terminal 1 determines whether or not the information from the core network 3 indicates the specific communication (step S309). If the information indicates the specific communication (step S309/Y), the mobile terminal 1 displays that the communication is the specific one (specific communication indication) on the display 507 (step S310). If the information does not indicate the specific communication (step S309/N), the mobile terminal 1 displays that the communication is the regular one (regular communication indication) on the display 507 (step S311).

With recent progress in IP (Internet Protocol) communication, the use of a IP telephone (Internet telephone) enables further reduction in communication fees for voice communication.

### BRIEF DESCRIPTION OF THE DRAWINGS

FIG. 1 is a diagram showing the configuration including a mobile communication system according to an embodiment of the present invention.

FIG. 2 is a block diagram showing the construction of a radio access network, a core network and a network according to the embodiment of the present invention.

FIG. 3 is a block diagram showing a mobile terminal according to the embodiment of the present invention.

FIG. 4 is a diagram showing the case where, in a communication fee service by which a specific communication fee is applied according to the embodiment of the present invention, the other communication party is a mobile terminal.

FIG. 5 is a diagram showing specific communication areas of a plurality of users who subscribe to a mobile communication carrier according to the embodiment of the present invention.

FIG. 6 is a diagram showing the case where, in a communication fee service by which a specific communication fee is applied according to the embodiment of the present invention, the other communication party is a mobile terminal using a public switched telephone network/unaffiliated mobile communication network.

FIG. 7 is a diagram for explaining a specific communication area in which a specific communication fee is applied according to the embodiment of the present invention.

FIG. 8 is a flowchart showing the display operation of a mobile terminal in standby mode according to the embodiment of the present invention.

FIG. 9 is a flowchart showing the calling operation of a mobile terminal according to the embodiment of the present invention.

FIG. 10 is a flowchart showing operation for reviewing the charge rate during communication according to the embodiment of the present invention.

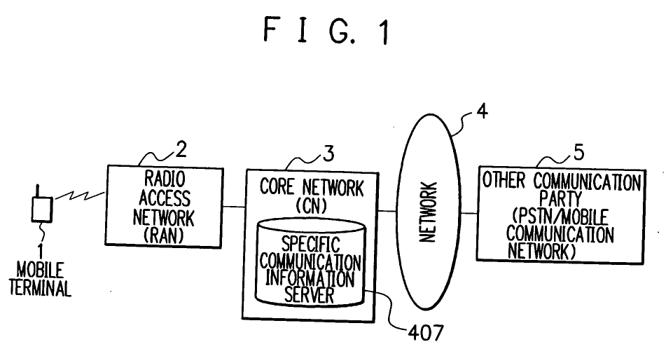

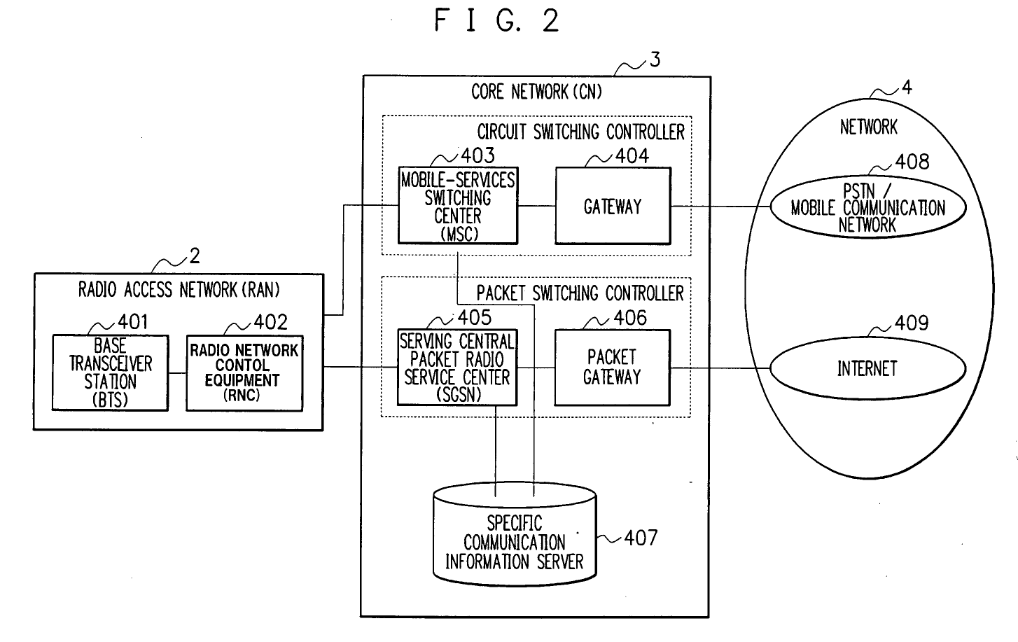

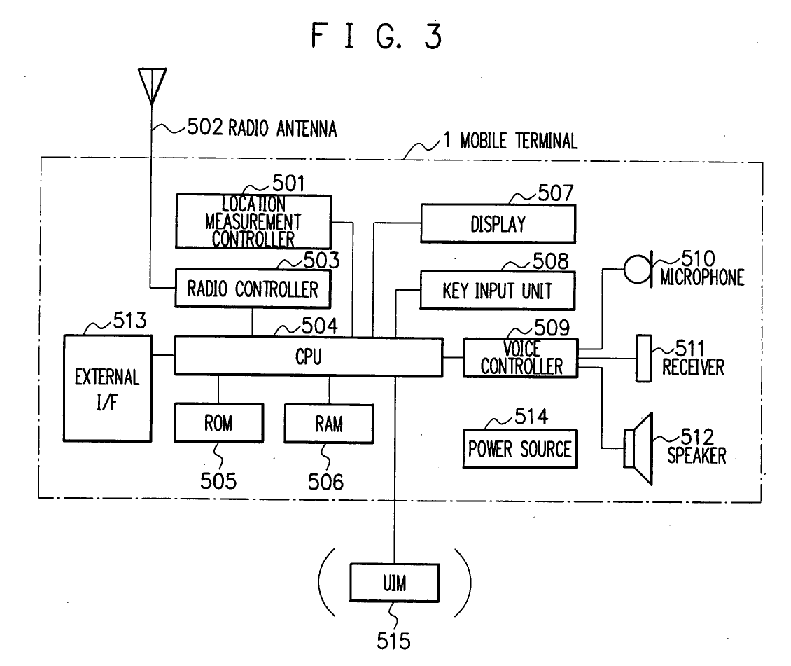

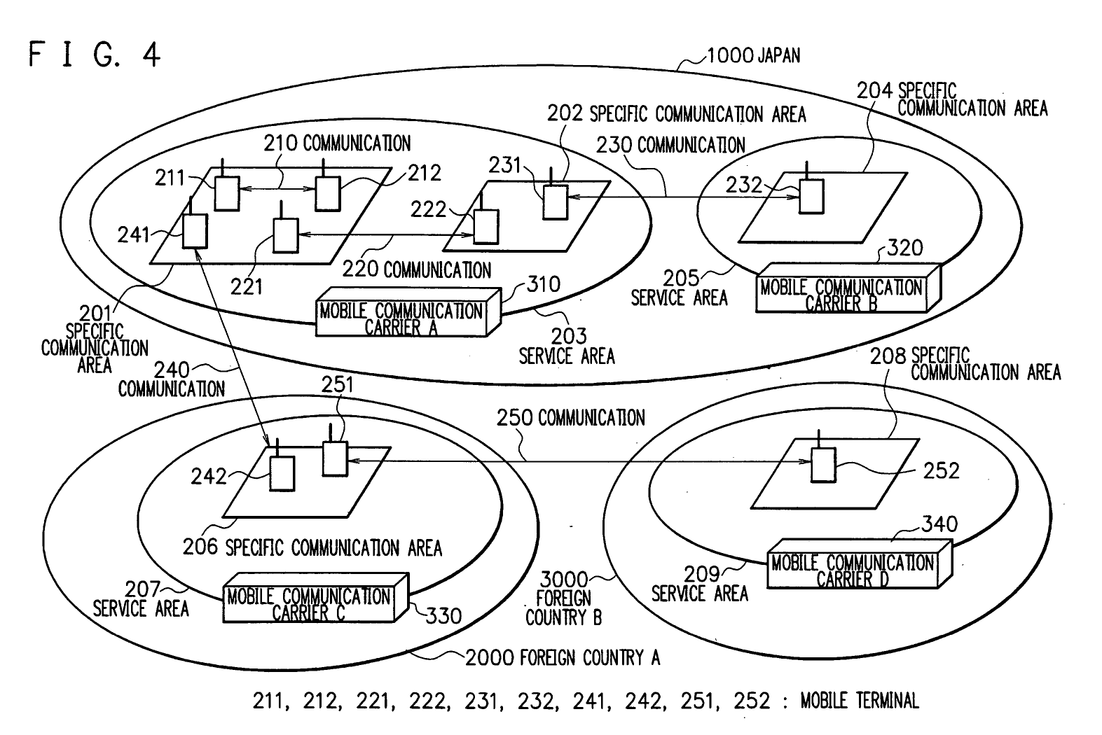

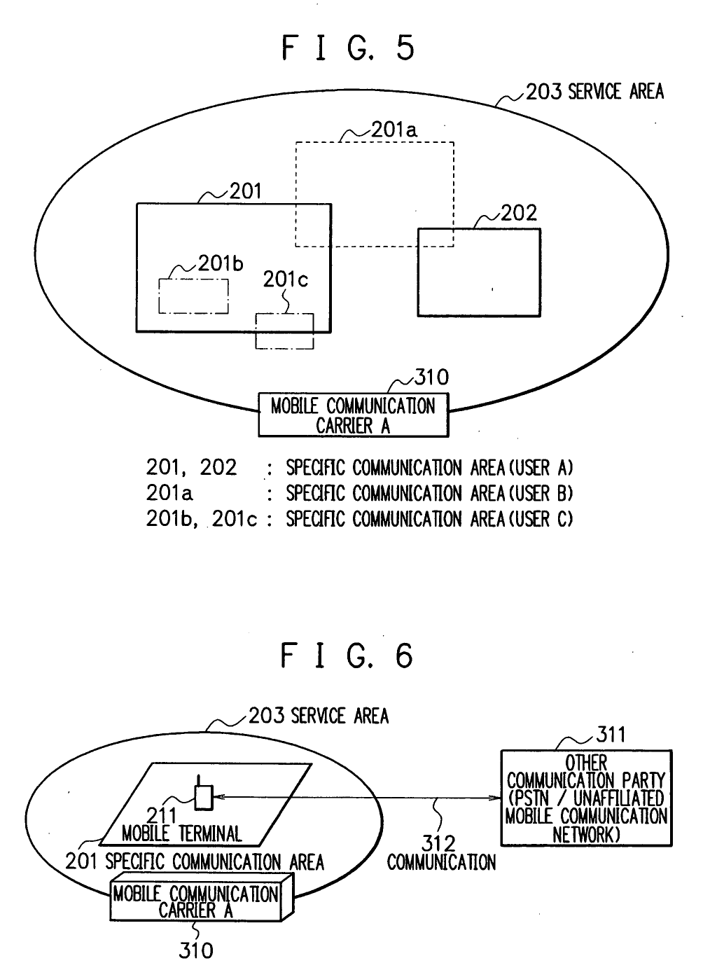

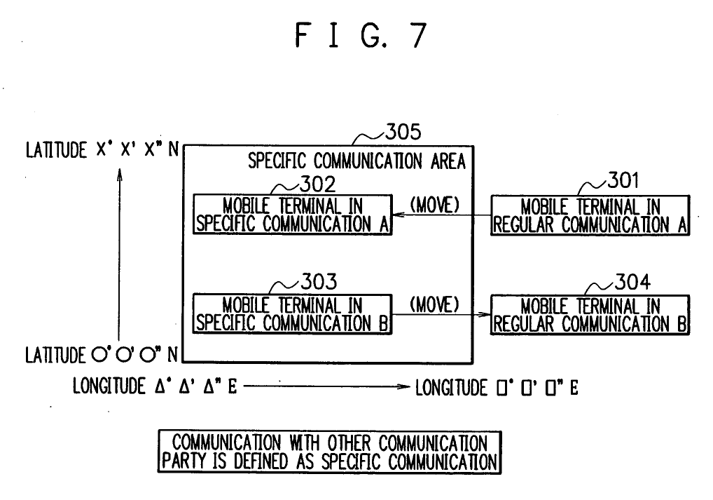

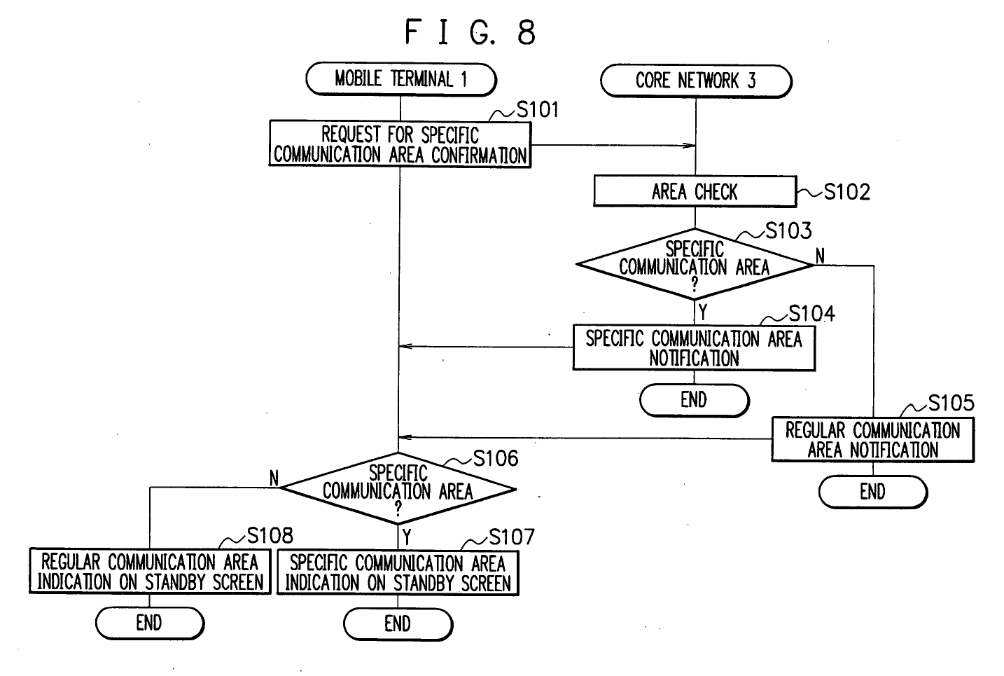

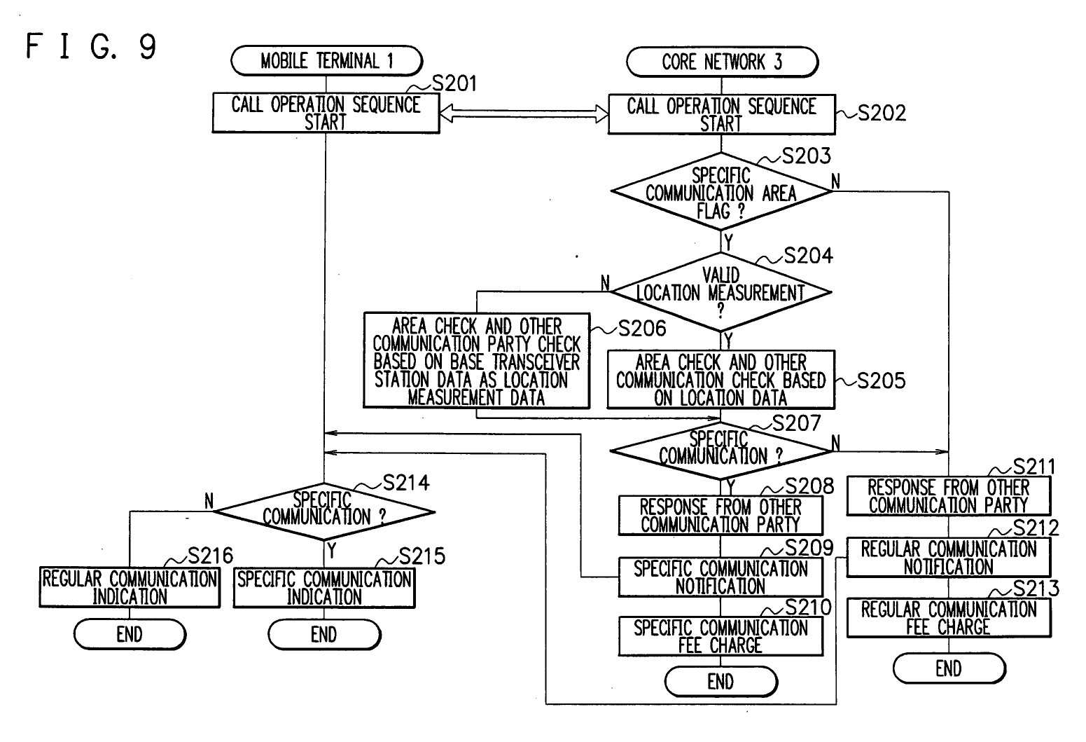

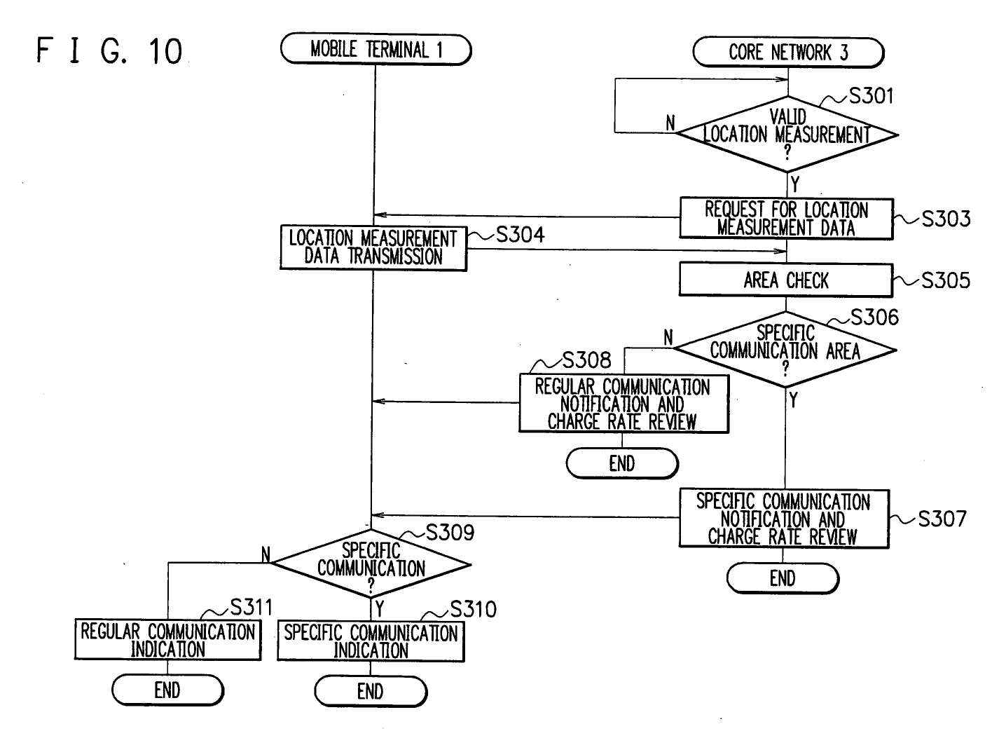

### DESCRIPTION OF CODES

1 Mobile terminal
2 Radio access network
3 Core network
4 Network
5 Other communication party
201, 201a, 201b, 201c, 202, 204, 206, 208 Specific communication areas
203, 205, 207, 209 Service area
211, 212, 221, 222, 231, 232, 241, 242, 251, 252 Mobile terminal
210, 220, 230, 240, 250 Communication
1000 Japan
2000 Foreign country A
3000 Foreign country B
301 Mobile terminal in regular communication
302 Mobile terminal in specific communication
303 Mobile terminal in specific communication
304 Mobile terminal in regular communication
305 Specific communication area
310 Mobile communication carrier A
311 Other communication party
312 Communication
320 Mobile communication carrier B
330 Mobile communication carrier C
340 Mobile communication carrier D
401 Base transceiver station
402 Radio network control equipment
403 Mobile-services switching center
404 Gateway
405 Serving central packet radio service center
406 Packet gateway
407 Specific communication information server
408 Public switched telephone network/mobile communication network
409 Internet
501 Location measurement controller
502 Radio antenna
503 Radio controller
504 CPU
505 ROM
506 RAM
507 Display
508 Key input unit
509 Voice controller
510 Microphone
511 Receiver
512 Speaker
513 External interface
514 Power source
515 UIM

1. A mobile communication system comprising:
a mobile terminal having a location measurement function;
a radio access network including a base transceiver station that has a session with the mobile terminal; and
a core network connected to the radio access network for performing circuit switching and packet switching;
wherein the core network includes a specific communication information server for storing:
information on a user who uses the mobile terminal;
information on one or more specific communication areas in which specific communication fees are applied to reduce communication fees for the mobile terminal; and
information on one or more other communication parties, communication with which is charged at the specific communication fees.

2. The mobile communication system claimed in claim 1, wherein the specific communication area is defined by a contract between the user of the mobile terminal and the mobile communication carrier that manages the mobile communication system.

3. The mobile communication system claimed in claim 1, wherein the specific communication areas are set by contract in the service areas of one or more mobile communication carriers each managing the mobile communication system in Japan and one or more mobile communication carriers each managing the mobile communication system abroad.

4. The mobile communication system claimed in claim 1, wherein, when the user of the mobile terminal makes a call, while located in the specific communication area, to a mobile terminal located outside the area, communication with which is charged by contract at the specific communication fee, the specific communication fee is applied to the call.

5. The mobile communication system claimed in claim 1, wherein when the mobile terminal is incapable of locating its position, the core network compares the past location measurement data of the mobile terminal obtained therefrom with location data obtained from the base transceiver station, and uses the location data as the location measurement data.

6. The mobile communication system claimed in claim 1, wherein the specific communication information server requests the mobile terminal for the location measurement data thereof while the mobile terminal is in communication.

7. The mobile communication system claimed in claim 1, wherein the mobile terminal displays that it is located in the specific communication area.

8. The mobile communication system claimed in claim 1, wherein the specific communication fee is determined according to the amount of traffic in the specific communication area.

9. A communication fee service method applied to a mobile communication system, wherein:
the user of mobile communication carrier's services defines one or more specific communication areas in the service area of the mobile communication carrier; and
the mobile communication carrier reduces fees charged to the user for communication in the specific communication area.

10. A communication fee service method applied to a mobile communication system, wherein:
a plurality of users of mobile communication carrier's services define their specific communication areas, respectively, in the service area of the mobile communication carrier; and
the mobile communication carrier reduces fees charged to each of the users for communication in the specific communication area.

11. The communication fee service method applied to a mobile communication system claimed in claim 10, wherein the specific communication areas of the respective users overlap partly or completely.

12. A communication fee service method applied to a mobile communication system, wherein, when a first specific communication area is set for a mobile terminal in the service area of a first mobile communication carrier and a second specific communication area is set for another mobile terminal in the service area of a second mobile communication carrier in business partnership with the first mobile communication carrier, the first mobile communication carrier reduces fees for communication between the mobile terminals in the first and second specific communication areas.

13. A communication fee service method applied to a mobile communication system comprising a mobile terminal having a location measurement function, a radio access network including a base transceiver station that has a session with the mobile terminal, and a core network connected to the radio access network for performing circuit switching and packet switching, the communication fee service method comprising the steps of:
the mobile terminal transmitting confirmation request data to request the core network to check whether or not the mobile terminal is located in its specific communication area;
the core network checking the location measurement data of the mobile terminal contained in the confirmation request data with information on the specific communication area of the mobile terminal defined by contract to determine whether or not the mobile terminal is located in the specific communication area;
the core network informing the mobile terminal, when the mobile terminal is located in the specific communication area, that the mobile terminal is located in the specific communication area; and
the mobile terminal displaying, when having been informed that the mobile terminal is located in the specific communication area, the indication of the specific communication area on the standby screen.

14. A communication fee service method applied to a mobile communication system comprising a mobile terminal having a location measurement function, a radio access network including a base transceiver station that has a session with the mobile terminal, and a core network connected to the radio access network for performing circuit switching and packet switching, the communication fee service method comprising the steps of:
the mobile terminal transmitting location measurement data and a flag indicating that the mobile terminal is located in its specific communication area to the core network;
the core network recognizing, when having received the flag, that the mobile terminal has been located in the specific communication area, and referring to the timestamp of the location measurement data to determine whether or not the location measurement data has expired;
the core network checking the area based on the location measurement data when the location measurement is still valid, and also checking the other communication party;
the core network checking the area based on the past location measurement data and location data of the mobile terminal obtained from the base transceiver station when the location measurement is already invalid, and also checking the other communication party;
the core network determining whether or not specific communication which is charged at a specific communication fee is to be performed based on the results of the checks for the area and the other communication party;
the core network informing the mobile terminal, when the specific communication is to be performed, that the communication to be performed is the specific one if the other communication party responds to the call, and charging the specific communication fee; and
the mobile terminal determining whether or not the information from the core network indicates the specific communication, and, when the information indicates the specific communication, displaying that the communication to be performed is the specific one.

15. A communication fee service method applied to a mobile communication system comprising a mobile terminal having a location measurement function, a radio access network including a base transceiver station that has a session with the mobile terminal, and a core network connected to the radio access network for performing circuit switching and packet switching, the communication fee service method comprising the steps of:
the core network requesting the mobile terminal for location measurement data;
the mobile terminal transmitting the location measurement data to the core network;
the core network receiving the location measurement data, and checking the area to determine whether or not it corresponds to a specific communication area;
the core network informing the mobile terminal, when the area corresponds to the specific communication area, that the communication is the specific one, and reviewing the charge rate; and
the mobile terminal determining whether or not the communication is the specific one, and, when the specific communication is being performed, displaying the indication of the specific communication.

16. A communication fee service program causing a computer to perform the functions of:
receiving from a mobile terminal confirmation request data requesting to check whether or not the mobile terminal is located in its specific communication area;
checking, on receipt of the confirmation request data, the location measurement data of the mobile terminal contained in the confirmation request data with information on the specific communication area of the mobile terminal defined by contract to determine whether or not the mobile terminal is located in the specific communication area; and
informing the mobile terminal, when the mobile terminal is located in the specific communication area, that the mobile terminal is located in the specific communication area.

17. A communication fee service program causing a computer to perform the functions of:
receiving from a mobile terminal location measurement data and a flag indicating that the mobile terminal is located in its specific communication area;
recognizing, when having received the flag, that the mobile terminal has been located in the specific communication area, and referring to the timestamp of the location measurement data to determine whether or not the location measurement data has expired;
checking the area based on the location measurement data when the location measurement is still valid, and also checking the other communication party;
checking the area based on the past location measurement data and location data of the mobile terminal obtained from a base transceiver station when the location measurement is already invalid, and also checking the other communication party;
determining whether or not specific communication which is charged at a specific communication fee is to be performed based on the results of the checks for the area and the other communication party; and
informing the mobile terminal, when the specific communication is to be performed, that the communication to be performed is the specific one if the other communication party responds to the call, and charging the specific communication fee.

18. A communication fee service program causing a computer to perform the functions of:
requesting a mobile terminal for location measurement data;
receiving the location measurement data, and checking the area to determine whether or not the mobile terminal is located in a specific communication area; and
informing the mobile terminal, when the mobile terminal is located in the specific communication area, that the communication is the specific one, and reviewing the charge rate.
